(19) United States
(12) Patent Application Publication
(10) Pub. No.: US 2005/0216275 A1
(43) Pub. Date: Sep. 29, 2005

(54) TELEPHONE APPARATUS FOR MAKING TELEPHONE CALLS IN CONJUNCTION WITH A COMPUTING DEVICE

(76) Inventor: Heng-Chien CHEN, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,764

(22) Filed: Mar. 24, 2004

(51) Int. Cl. G10L 11/00

(52) U.S. Cl. 704/277

(57) ABSTRACT

A telephone apparatus for use in conjunction with a computing device. The computing device executes a telephone software application for making telephone calls over the Internet. The telephone apparatus includes an interface for receiving downstream audio packages from the computing device and for sending upstream audio packages to the computing device, and a voice compression/decompression circuit for decompressing the downstream audio packages received through the interface and for compressing upstream audio packages sent to the interface according to a predetermined voice compression protocol. An audio codec converts the decompressed downstream audio packages received from the voice compression/decompression circuit into downstream analog signals, and converts upstream analog signals into upstream audio packages sent to the voice compression/decompression circuit. An analog audio interface outputs the downstream analog signals and receives upstream analog signals.

### BACKGROUND OF INVENTION

1. Field of the Invention

The present invention relates to a telephone apparatus, and more specifically, to a telephone apparatus connecting to a computing device for reducing the processing burden put on the computing device while making phone calls.

2. Description of the Prior Art

In recent years, the popularity of the Internet, combined with the increase in computing power of computers and other computing devices, has led to the popularity of soft phones. A soft phone is an Internet Protocol (IP) phone implemented only in software. The soft phone can be implemented on any kind of computing device that runs software. Computers are usually used for executing the soft phone due to their relatively high processing power.

Please refer to FIG. 1. FIG. 1 is a diagram of two soft phones 14 and 16 communicating with each other according to the prior art. Each soft phone 14 and 16 is connected to the Internet 10, and communicates with each other through the Internet 10. A host 12 is used to connect the soft phone 14 with the soft phone 16 for making a telephone call. As is well known in the prior art, the H.323 standard is often used for providing the framework for voice communication across IP-based networks, and the H.323 standard can be used for enabling the soft phones 14 and 16 to communicate with each other.

Unfortunately, since soft phones are merely a software implementation of an IP phone, it is very easy to copy or pirate soft phone soft software. In addition, the process of encoding and compressing voice packet data to be sent over the Internet is very demanding on a computing device's central processing unit (CPU). Moreover, the soft phone also has to decompress and decode voice packet data that is received over the Internet. Having to perform signal processing on both incoming and outgoing data doubles the load on the CPU. While newer CPUs are capable of handling these signal processing demands, the general purpose CPU is not designed specifically for the type of calculations that the soft phone application requires. Therefore, the load placed on the CPU of a computing device running a soft phone will be very great, and will cause a noticeable decrease in performance. This decrease in performance is especially obvious when other software applications are running at the same time as the soft phone software.

### SUMMARY OF INVENTION

It is therefore an objective of the claimed invention to provide a telephone apparatus that is used in conjunction with a computing device in order to solve the above-mentioned problems.

According to the claimed invention, a telephone apparatus for use in conjunction with a computing device is proposed. The computing device executes a telephone software application for making telephone calls over the Internet. The telephone apparatus includes an interface for receiving downstream audio packages from the computing device and for sending upstream audio packages to the computing device, and a voice compression/decompression circuit for decompressing the downstream audio packages received through the interface and for compressing upstream audio packages sent to the interface according to a predetermined voice compression protocol. An audio codec converts the decompressed downstream audio packages received from the voice compression/decompression circuit into downstream analog signals, and converts upstream analog signals into upstream audio packages sent to the voice compression/decompression circuit. An analog audio interface outputs the downstream analog signals and receives upstream analog signals.

It is an advantage of the claimed invention that the telephone apparatus is a hardware solution for use in conjunction with the computing device. Therefore, the telephone apparatus is difficult to pirate. In addition, the signal processing required for making telephone calls over the Internet is all performed by the telephone apparatus, thereby reducing the load on the CPU of the computing device.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of two soft phones communicating with each other according to the prior art.

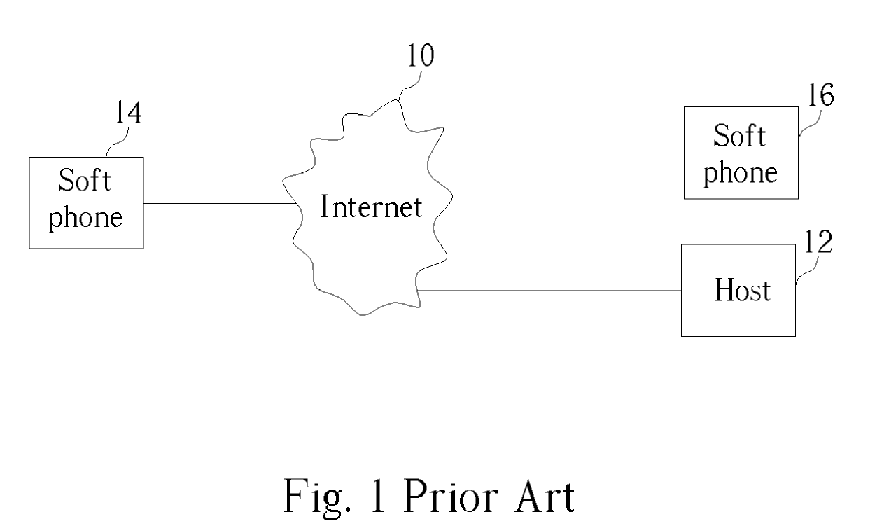

FIG. 2 is a diagram of an IP-based communication network according to the present invention.

FIG. 3 is a block diagram of a telephone apparatus connecting to a computing device.

FIG. 4 is a detailed block diagram of the telephone apparatus according to the present invention.

FIG. 5 is a diagram showing different ways of inputting audio signals to the telephone apparatus and outputting audio signals from the telephone apparatus.

### DETAILED DESCRIPTION

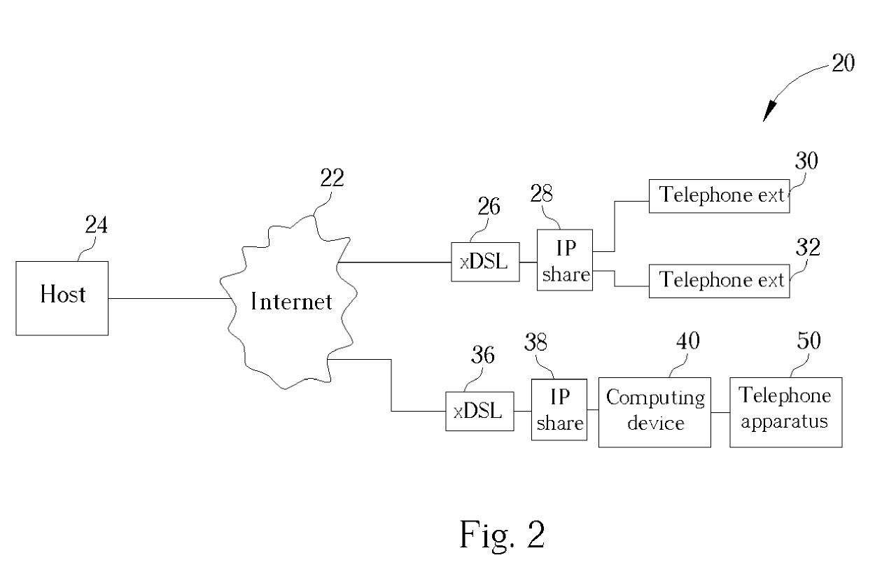

Please refer to FIG. 2. FIG. 2 is a diagram of an IP-based communication network 20 according to the present invention. The IP-based communication network 20 enables a computing device 40 used in conjunction with a telephone apparatus 50 to communicate with telephone extensions 30 and 32 via the Internet 22. The telephone extensions 30 and 32 are connected to the Internet 22 through an Internet connection 26. An IP sharing device 28 shares the Internet connection 26 with each of the telephone extensions 30 and 32. Similarly, The computing device 40 is also connected to the Internet 22 through an Internet connection 36 and an IP sharing device 38. The Internet connections 26 and 36 may be an xDSL connection or another suitable broadband Internet connection. A host 24 is used to manage telephone connections made through the IP-based communication network 20. The IP-based communication network 20 preferably operates according to the H.323 standard for communication over IP-based networks.

The computing device 40 may be a computer, a personal digital assistant (PDA), or other similar computing devices that are capable or executing software programs. Any kind of computer can be used such as a desktop PC, a notebook computer, or a MACINTOSH®. Unlike the prior art, the telephone apparatus 50 is used together with the computing device 40 to provide the functionality of a soft phone.

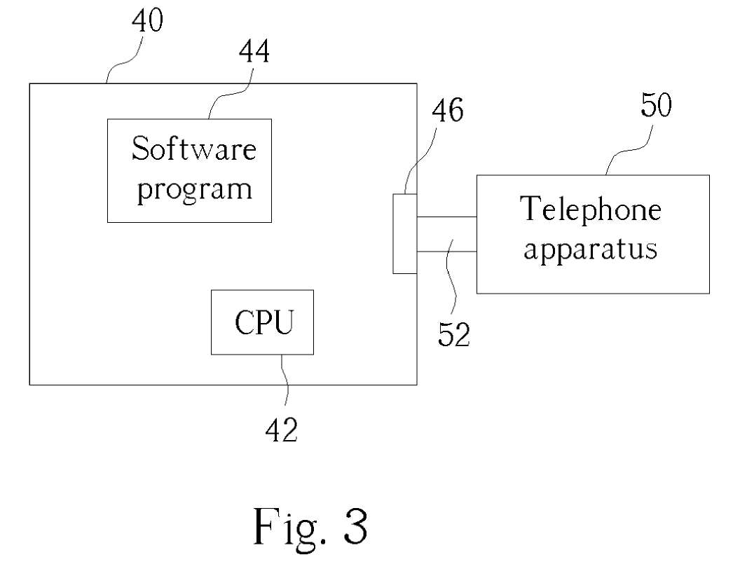

Please refer to FIG. 3. FIG. 3 is a block diagram of the telephone apparatus 50 connecting to the computing device 40. The computing device 40 has an interface 46 for communicating with an interface 52 of the telephone apparatus 50. The interfaces 46 and 52 may be any interface 52 that can be used to transfer data. For example, possible standards that the interfaces 46 and 52 may follow include, but are not limited to, the Universal Serial Bus (USB) standard, the IEEE 1394 standard, or the Ethernet (IEEE 802.3) standard. The computing device 40 contains a CPU 42 for executing a software program 44. The software program 44 is used for providing a user interface and basic functionality needed for the computing device 40 to make IP-based telephone calls.

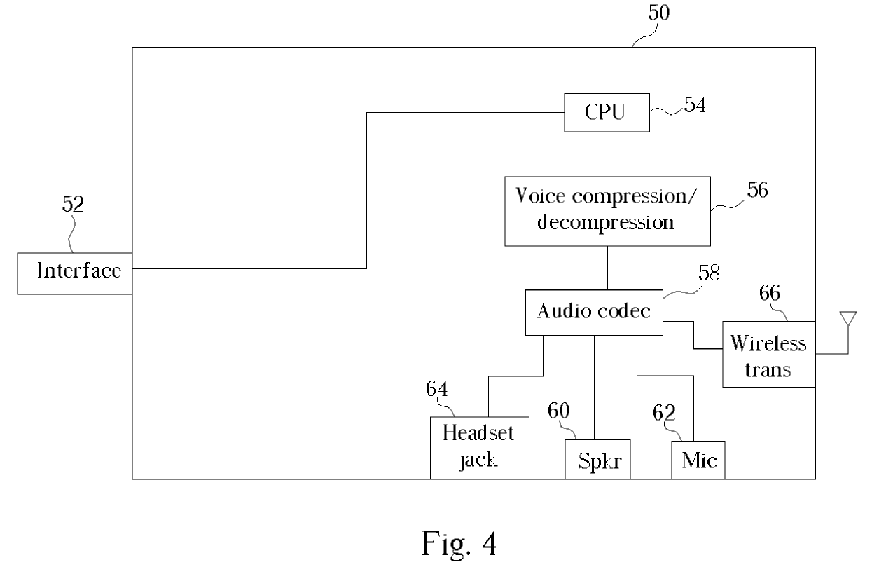

Please refer to FIG. 4. FIG. 4 is a detailed block diagram of the telephone apparatus 50 according to the present invention. The telephone apparatus 50 will receive downstream audio packages from the computing device 40 through the interface 52 of the telephone apparatus 50. Downstream audio packages are incoming audio packages received by the computing device 40 through the Internet 22 whereas upstream audio packages are those transmitted by the computing device 40 through the Internet 22. The audio packages received through the interface 52 are in a compressed digital format. The audio packages are sent from the interface 52 to a CPU 54 of the telephone apparatus 50. The CPU 54 is used for controlling operation of the telephone apparatus 50. The CPU 54 sends the audio packages to a voice compression/decompression circuit 56, which decompresses the downstream audio packages. The voice compression/decompression circuit 56 preferably adheres to one of the G.7xx voice compression protocols. These G.7xx voice compression protocols include, but are not limited to, G.711, G.721, G.722, G.726, G.727, G.728, G.729, G.729A, and G.729B. The voice compression/decompression circuit 56 then sends the decompressed digital audio packages to an audio codec 58. The audio codec 58 converts the decompressed digital audio packages into analog audio signals. The audio codec 58 preferably conforms to the Audio Codec “97 specification, although other codecs can also be used.

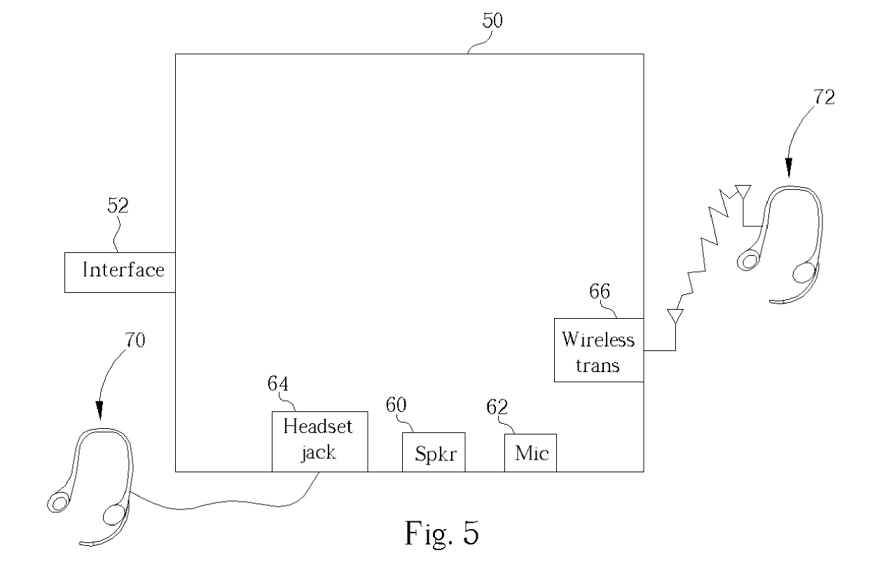

Please refer to FIG. 4 and FIG. 5. FIG. 5 is a diagram showing different ways of inputting audio signals to the telephone apparatus 50 and outputting audio signals from the telephone apparatus 50. The analog audio signals produced by the audio codec 58 can be output from the telephone apparatus 50 in a variety of ways. For example, the telephone apparatus 50 may output analog audio signals through a speaker 60. Also, the telephone apparatus 50 contains a headset jack 64 for outputting the analog audio signals to a headset 70. The telephone apparatus 50 may also be designed to have a wireless transceiver 66 for wirelessly outputting audio signals to a wireless headset 72.

Similarly, analog audio signals can be input to the telephone apparatus 50 in a variety of ways. The telephone apparatus 50 contains a microphone 62 for inputting upstream analog audio signals. In addition, a microphone on the headset 70 can also be used, and the headset 70 will input the analog audio signals through the headset jack 64. Likewise, the wireless headset 72 can also be used to input audio signals to the telephone apparatus 50 through the wireless transceiver 66.

The headset jack 64, the microphone 62, and the wireless transceiver 66 send analog audio signals to the audio codec 58. The audio codec 58 then converts the analog audio signals into a digital format, and sends the decompressed digital signals to the voice compression/decompression circuit 56. The voice compression/decompression circuit 56 compresses the digital signals into compressed audio packages, and sends the compressed audio packages to the interface 52 via the CPU 54. The telephone apparatus 50 then transmits the audio packages to the computing device 40, and the computing device 40 sends the upstream audio packages out through the Internet 22. The IP-based communication network 20 then sends the audio packages to one of the telephone extensions 30 or 32, depending on which telephone extension has a telephone connection with the computing device 40.

Since the telephone apparatus 50 has a speaker 60 and microphone 62, a user of the telephone apparatus 50 can use telephone apparatus 50 as a speakerphone with hands free operation. Furthermore, the telephone apparatus 50 can also be used in a hands free manner with either the headset 70 or the wireless headset 72.

In summary, the present invention telephone apparatus 50 is used together with the computing device 40 to provide the functionality of a soft phone. Since the telephone apparatus 50 is a hardware device, and is not purely a software program, the telephone apparatus 50 of the present invention is difficult to pirate. In addition, all of the computationally intensive calculations such as encoding, decoding, compression, and decompression are performed in the telephone apparatus 50, thereby reducing the load placed on the CPU 42 of the computing device 40.

Those skilled in the art will readily observe that numerous modifications and alterations of the device may be made while retaining the teachings of the invention. Accordingly, the above disclosure should be construed as limited only by the metes and bounds of the appended claims.

1. A telephone apparatus for use in conjunction with a computing device, the computing device executing a telephone software application for making telephone calls over the Internet, the telephone apparatus comprising:
an interface for receiving downstream audio packages from the computing device and for sending upstream audio packages to the computing device;
a voice compression/decompression circuit for decompressing the downstream audio packages received through the interface and for compressing upstream audio packages sent to the interface according to a predetermined voice compression protocol;
an audio codec for converting the decompressed downstream audio packages received from the voice compression/decompression circuit into downstream analog signals, and for converting upstream analog signals into upstream audio packages sent to the voice compression/decompression circuit; and
an analog audio interface for outputting the downstream analog signals and for receiving upstream analog signals.

2. The telephone apparatus of claim 1 further comprising a processor for controlling operation of the telephone apparatus.

3. The telephone apparatus of claim 1 wherein the audio codec conforms to the Audio Codec “97 specification.

4. The telephone apparatus of claim 1 wherein the predetermined voice compression protocol is a G.7xx voice compression protocol.

5. The telephone apparatus of claim 1 further comprising a microphone connected to the analog audio interface for inputting upstream analog signals to the telephone apparatus.

6. The telephone apparatus of claim 1 further comprising a speaker for outputting the downstream analog signals from the telephone apparatus.

7. The telephone apparatus of claim 1 further comprising a headset jack formed for receiving a plug of a headset.

8. The telephone apparatus of claim 1 further comprising a wireless transceiver for receiving wireless digital upstream signals from a wireless headset and for transmitting wireless digital downstream signals to the wireless headset.

9. The telephone apparatus of claim 1 wherein the interface that the telephone apparatus uses to communicate with the computing device is a Universal Serial Bus (USB) interface.

10. The telephone apparatus of claim 1 wherein the interface that the telephone apparatus uses to communicate with the computing device is an IEEE 1394 interface.

11. The telephone apparatus of claim 1 wherein the interface that the telephone apparatus uses to communicate with the computing device is an Ethernet (IEEE 802.3) interface.
